(19) United States
(12) Patent Application Publication
(10) Pub. No.: US 2014/0297529 A1
(43) Pub. Date: Oct. 2, 2014

(54) Point Of Access Device For Use With A Mobile Device

(71) Applicant: Kachyng, Inc., San Francisco, CA (US)

(72) Inventor: Resh Wallaja, San Francisco, CA (US)

(73) Assignee: Kachyng, Inc., San Francisco, CA (US)

(21) Appl. No.: 14/213,545

(22) Filed: Mar. 14, 2014

Related U.S. Application Data
(60) Provisional application No. 61/785,969, filed on Mar. 14, 2013.

(51) Int. Cl. G06Q 20/40; G06Q 20/34

(52) U.S. Cl. CPC G06Q 20/40145; G06Q 20/353
USPC 705/44

(57) ABSTRACT

Methods and systems relating to enabling a transaction are described. The system includes a point of access device comprising a magnetic card reader adapted to read financial data stored on a magnetic stripe of a card, a fingerprint sensor adapted to detect fingerprint data of a user, a processor adapted to generate an analog signal encoding the financial data and the fingerprint data. The system further includes a transaction processing system comprising an interface for receiving the analog signal and a processor for processing the analog signal and enabling the financial transaction based on the processed signal. The system may further include a mobile phone coupled to the point of access device. The mobile phone receive the analog signal from the point of access device and transmits the analog signal to the transaction processing system.

### CROSS-REFERENCE TO RELATED APPLICATIONS

This application claims the benefit of U.S. Provisional Application No. 61785,969, filed Mar. 14, 2013, which is incorporated herein by reference in its entirety.

### BACKGROUND

1. Field of Art

This disclosure relates generally to a point of access device for use with a cellular phone for reading a magnetic stripe card, and more particularly to a portable point of access device which senses the magnetically recorded information stored on a magnetic stripe card and conveys this sensed information via an analog waveform to a cell phone for further processing.

2. Description of the Related Art

Plastic cards having a magnetic stripe embedded on one side of the card are prevalent in every day commerce. These cards are used in various transactions, such as to pay for purchases by using a credit card, a debit card, or a gasoline charge card. Data is stored on magnetic stripe card by modifying the magnetism of magnetic particles embedded in the stripe. The data stored on the magnetic stripe may be sensed or read by swiping the stripe past a read head. The read head obtains an analog waveform obtained by sensing the magnetic stripe. The analog waveform is decoded to obtain the digital information stored in the magnetic stripe of the card.

Magnetic stripe cards provide a convenient mechanism for consumers to transfer money to merchants to purchase goods or services from the merchants. However, it is often difficult for merchants, especially individuals without access to fixed point of sale devices as found in large retail locations, to accept payment using magnetic stripe cards. Therefore, it is desirable to have a portable point of access device that enables merchants to more easily receive payment via magnetic stripe cards.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a top perspective view of a point of access device according to an embodiment.

FIG. 2 is a an embodiment of a system including a point of access device according to an embodiment.

FIG, 3 is a schematic diagram of an embodiment of a point of access device.

FIG. 4 is a block diagram illustrating modules within device software of the point of access device according to an embodiment.

FIG. 5 is a schematic diagram of an embodiment of a computing device that can be used as a remote host system.

FIG. 6 is a flowchart of a process for authorizing a transaction using the point of access device according to an embodiment.

FIG. 7 illustrates a schematic block diagram of a tow-cost biometric authorization system according to an example embodiment.

FIG. 8 illustrates a method of using a radio as a low-cost biometric authorization device according to an example embodiment.

FIG. 9 illustrates a data structure representing an SMS, such as may be transmitted by radio or processing server.

FIG, 10 illustrates a database structure for storing user account data in accordance with certain example embodiments.

### DETAILED DESCRIPTION

Those of ordinary skill in the art will realize that the following description of various embodiments is illustrative only and not in any way limiting. Other embodiments will readily suggest themselves to such skilled persons, having the benefit of this disclosure. Reference will now be made in detail to specific implementations as illustrated in the accompanying drawings. The same or similar reference numbers will be used throughout the drawings and the following description to refer to the same or like parts.

Embodiments provide for a point of access device for verifying monetary transactions to be used in conjunction with a cell phone or other mobile device. Further, in some embodiments, the point of access device provides security features, such as enabling a seller to propose a transaction and enabling a buyer to confirm the proposed transaction with a fingerprint scan. The point of access device provides these functions without requiring any changes to the hardware of the cell phone. Further, in some embodiments, the cell phone does not perform any of the data processing, which is instead performed at a remote transaction processing system.

The point of access device includes an analog audio output port that can be coupled to a generic cellular phone microphone input port. The device uses the cellular phone microphone channel to transmit modulated data that includes an encrypted rendering of magnetic card swipe data and a fingerprint scan data.

In some embodiments, the point of access device is portable and thereby can allow an individual to conveniently receive or send payment with a magnetic stripe card. Further, the point of access device can be connected to a cell phone with the cell phone not requiring new software or applications programmed therein. The cell phone transmits raw audio signal received from the point of access device to a host system, which performs a decoding function to decode data contained on a magnetic stripe and fingerprint data to process credit authentication requests.

In some embodiments, the point of access device enables a seller to propose a transaction and a buyer to confirm the proposed transaction with a fingerprint scan. The point of access device includes a magnetic stripe reader and a fingerprint scan module to capture magnetic card swipe data and fingerprint data respectively. The device uses the cellular phone microphone channel to transmit modulated data that includes an encrypted rendering of magnetic card swipe data and a fingerprint scan data. The modulated data is processed at a remote host system to complete the transaction.

Although the embodiments discussed herein refer to fingerprint scan data, other types of biometric data can additionally or alternatively be used. For instance, in another embodiment, point of access device includes an iris scanner, or both a fingerprint scanner and an iris scanner.

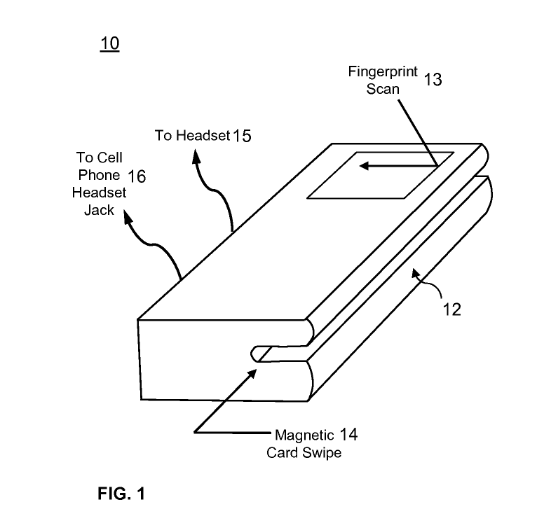

With reference now to FIG. 1, the point of access device 10 is shown to comprise a housing 12 having a slot 14, an audio output 16 to couple the point of access device 10 to a mobile device (such as a cell phone), and a coupling mechanism 15 to couple a cellphone headset device with the point of access device 10.

The slot 14 is wide enough and deep enough to accept a card having a magnetic stripe. In particular, the slot 14 is deep enough that the magnetic stripe will fit within the slot 14. In one embodiment, the length of slot 14 is shorter than the length of the card to be inserted into the slot 14. However, the slot 14 may have other lengths if desired, for a given application. The housing 12 may take on different shapes and sizes, as will be discussed further herein.

The point of access device 10 also includes a biometric sensor, such as a fingerprint scanner 13. The fingerprint scanner 13 collects fingerprint data of a user to identify the user using the card. Accordingly, device 10 is configured to capture data from a magnetic card swipe and a fingerprint scan.

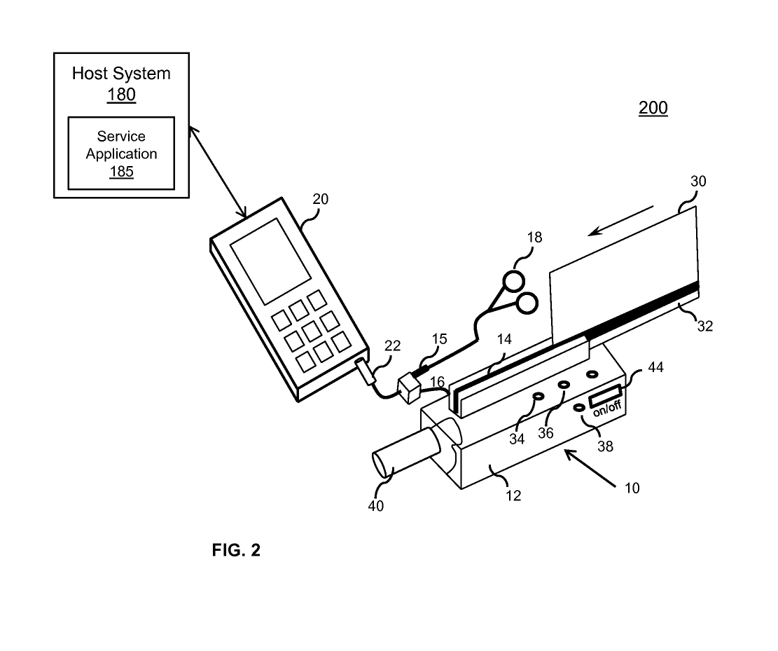

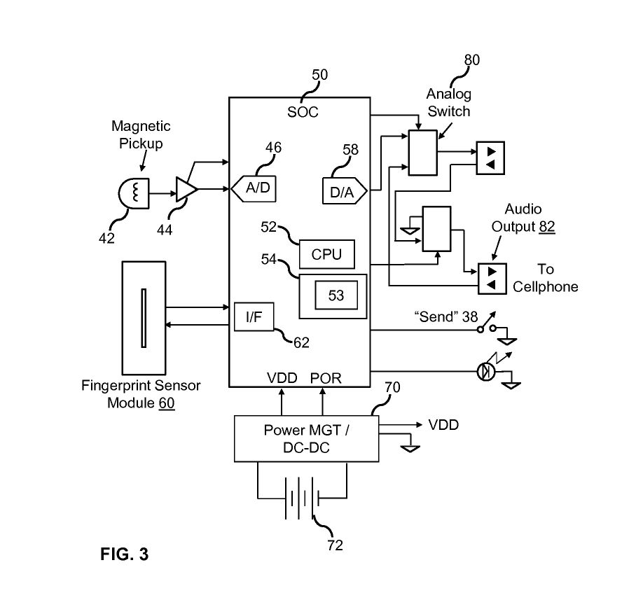

FIG. 2 illustrates an embodiment of a system 200 including the point of access device 10. System 200 includes a point of access device 10 coupled to a cell phone 20, which in turn is in communication with a host system 180, for example via a mobile communications network.

In one embodiment, the audio output 16 of the point of access device 10 includes a wire(as shown) that connects a socket in point of access device 10 to a socket, such as a microphone input or a line-in audio input 22, of a cell phone 20. However, the audio output 16 may be configured differently than illustrated in FIG. 2, instead comprising, for example, an audio jack.

In one embodiment, coupling mechanism 15 couples a cellular phone headset 18 with the device 10. In another embodiment, coupling mechanism 15 includes a jack (not shown), such as a TRS (tip, ring, sleeve) connector also known as an audio jack, phone plug, jack plug, stereo plug, mini-jack, or mini-stereo audio connection. The jack may be formed of different sizes such as miniaturized versions that are 3.5 mm or 2.5 mm. The jack may protrude out of device 10 and may be retractable within the housing 12.

The device may also include a send button 38 and one or more indicators 34 and 36, for example to indicate that a magnetic card swipe or fingerprint scan is in progress or that a magnetic card swipe or fingerprint scan was property captured. In some embodiments, indicator 34 indicates that the device 10 is ready to scan, and indicator 36 indicates status of a transmission, such as a transmission to cellular phone 20.

Device 10 may have its own power source, illustrated in FIG. 2A as a battery 40. Device 10 may also have an on-off switch 44 to conserve power. In another embodiment, the device 10 may be powered from a power source resident in the cell phone 20 via the audio output 16 when the device 10 is coupled to the cell phone 20.

In an example use, a merchant plugs a cellular phone headset 18 into the point of access device 10 and couples the device 10 with the cellular phone 20 via the audio output 16. A customer purchasing goods or services from the merchant swipes a card 30 having a magnetic stripe 32 through slot 14 of device 10. The magnetic strip 32 of the card 30 stores financial data of the user, such as a financial account number and an identifier of the customer's bank. The device 10 reads the magnetic stripe 32 to determine the customer's financial data. The customer using card 30 swipes a finger across the fingerprint sensor 13, and the fingerprint sensor 13 obtains fingerprint characterization data for the customer. The point of access device 10 encrypts the magnetic stripe data and the fingerprint data, and modulates the encrypted data for transmission via the cellular phone audio channel using the audio output 16. Specifically, the point of access device 10 sends the modulated waveform to the microphone input socket 22 of the cell phone 20 via the audio output 16. In one embodiment, the device 10 transmits the modulated data to the cell phone 20 by a unidirectional push operation. The push operation may be initiated when a user presses the “send” button 38 on the point of access device 10. Alternatively, the push operation may be initiated automatically, for example when a specified amount of data is captured.

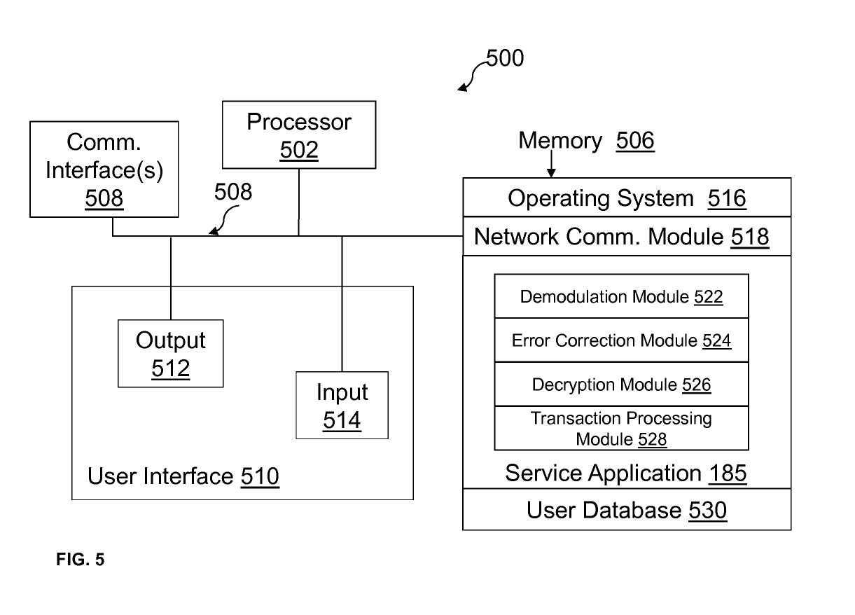

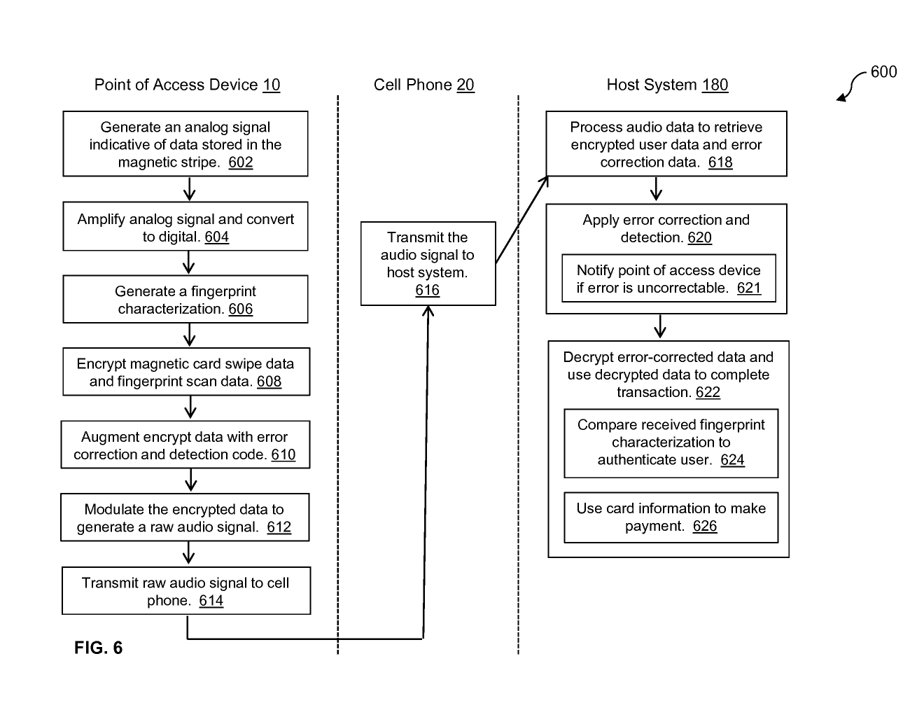

The cell phone 20 receives a raw audio signal rendering of user data (representing magnetic swipe data and finger scan data) via the cellular phone audio channel. In one embodiment, the cell phone 20 does not perform any processing of the received user data, and instead transmits the data to the remote host system 180 (e.g., via a mobile communication network) for processing. The remote host system 180 is discussed further with reference to FIGS. 5 and 6.

In one embodiment, at least a portion of the processing of the user data is performed at a remote host system 180, such as a third party or a company that handles credit authentication requests. Accordingly, the cell phone 20 may communicate with the host system 180 via the cell phone network, WiFi, Bluetooth, or other wireless communication modes. The host system 180 may send a signal to the cell phone 20 to indicate that the data was received at the host system 180. In one embodiment, the host system 180 executes a service application 185, which processes the financial data and fingerprint data received from the cell phone 20. The service application 185 performs recognition of the fingerprint characterization data to identify the person whose fingerprint data was collected and/or to verify the identity of the user of the card 30. Responsive to verifying the identity of the user using the fingerprint data, the service application 185 completes a financial transaction using the financial data.

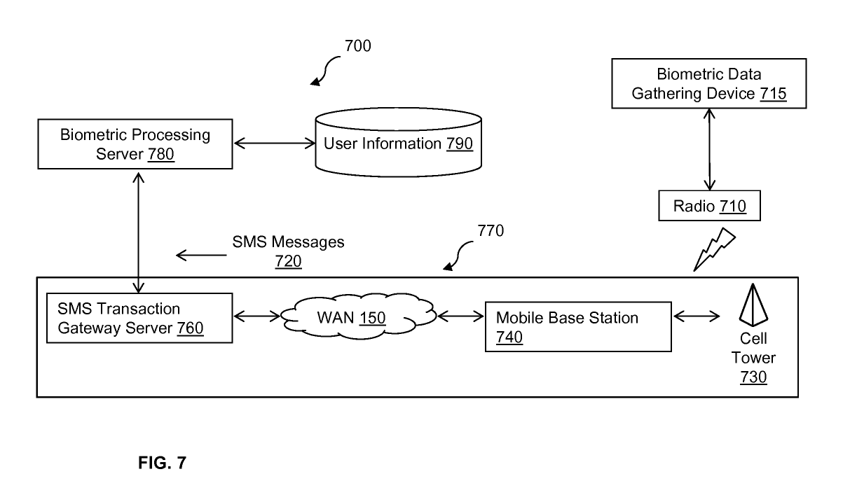

Although FIG. 2 illustrates the point of access device 10 communicating data to the remote host system 180, other embodiments of the point of access device 10 include a radio antenna to communicate data indicative of magnetic stripe data and data indicative of fingerprint data to remote host system 180, without passing it through a cellular phone 20. In some embodiments, the data is sent over an Internet protocol (IP)-based network. In some embodiments, the data is sent via SMS messages, as described further with reference to FIGS. 7-9.

Turning now to FIG, 3, illustrated is a schematic diagram of the point of access device 10. The point of access device 10 includes a system on a chip (SOC) 50 with one or more embedded processors (e.g., CPU) 52, memory 54, and various peripheral ports to support a magnetic card reader (e.g., A/D port or digital input ports 46), fingerprint reader (e.g., serial, I2C or SPI ports 62), and a modulated analog output (e.g., D/A port 58). In one embodiment, the point of access device 10 includes a magnetic card reader 42 coupled to the input port 46, a fingerprint sensor module 60 coupled to the interface 62, and one or more analog switches 80 coupled to the D/A port 58. In one embodiment, the analog switches 80 control an audio output 82, which in one embodiment couples the point of access device 10 to the cell phone 20.

In one embodiment, a power management module 70 provides regulated power (e,g., VDD supply) and a power-on reset (pop) to the SOC 50. Point of access device 10 may be powered by a field replaceable battery system 72. In one embodiment, SOC 50 provides battery monitoring provisions. For example, VDD may be transmitted to an A/D channel of the SOC 50 (via a switched resistor divider), which uses VDD to monitor the battery 72.

The magnetic pickup 42, which comprises, for example, a commodity card reader or tape reader pickup, generates an analog pickup signal in response to a user swiping a magnetic card in close proximity (e.g., through the slot 14 in the device enclosure 12, as shown in FIG. 2A). As the magnetic stripe 32 of the card 30 is passed by the magnetic pickup 42, the magnetic pickup 42 reads data or information stored in the magnetic stripe 32. Data stored in the magnetic stripe 32 may be in the form of magnetic transitions as described in the ISO 7811 standards.

A pickup amplifier 44 is coupled to the magnetic pickup 42. The pickup amplifier 44 amplifies a relatively low amplitude signal generated by the magnetic pickup 42 for sampling by the SOC 50. In one embodiment, the pickup amplifier 44 is configured to generate a digital interrupt signal to the SOC 50 to alert the SOC 50 that a magnetic swipe is in progress and to sample the pickup amplifier 44.

The analog to digital converter (ADC) 46 samples the amplified waveform input to the SOC 50 by the amplifier 44, converting the analog waveform into digital samples. The ADC 46 inputs the digital samples to the CPU 52 for processing.

As shown in FIG. 3, the fingerprint sensor module 60 of the point of access device 10 is coupled to the SOC 50 via the interface 62, such as a high-speed serial interface, a serial peripheral interface (SPI), or a USB interface. The fingerprint sensor module 60 generates a fingerprint characterization of a user's fingerprint, for example when a user swipes a finger over the fingerprint sensor 13 shown in FIG. 1. In one embodiment, the fingerprint sensor module 60 generates fingerprint characterization data that is small enough to be readily transmitted over an audio channel but having sufficient resolution to uniquely identify a user.

The CPU 52 receives the data from the magnetic pickup 42 and the fingerprint sensor module 60 and modulates the data for output by the audio output 82. When the CPU 52 transmits modulated data to the cell phone 20, the analog switches 80 mute audio of the user's headset 18 and switch the microphone source presented to the cell phone 20 via the SOC audio output 82. In one embodiment, the CPU 52 generates the modulated audio output at a signal level approximating that of a headset microphone compatible with the cell phone 20.

The memory 54 on SOC 50 stores device software 53 that is executed by one or more processors, such as the CPU 52. In one embodiment, the device software 53 causes the CPU 52 to read the magnetic pickup sensor 42 to retrieve data stored on a swiped magnetic card, read data from the fingerprint sensor 60, and transmit the data via a digital to analog output port 58 on the SOC 50. The device software 53 may also cause the CPU 52 to perform housekeeping functions. For example, device software 53 may cause the CPU 52 to perform battery level monitoring (e.g., via an on-chip A/D converter), wake-up on interrupt services, and the like.

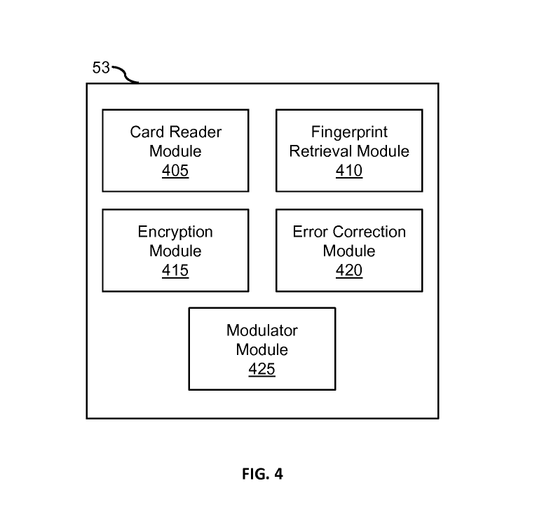

FIG. 4 is a block diagram illustrating modules within the device software 53, according to one embodiment. In one embodiment, the device software 53 comprises a card reader module 405, a fingerprint retrieval module 410, an encryption module 415, an error correction module 420, and a modulator module 425. Other embodiments of the device software 53 may include fewer or additional modules, such as modules that when executed by the CPU 52 cause the CPU 52 to perform housekeeping functions.

The card reader module 405 receives a raw magnetic signal from the magnetic pickup 42 and/or amplifier 44 and produces a data string corresponding to data stored on a swiped magnetic card 30. In one embodiment, the card reader module 405 is triggered by a wake-up interrupt generated by the magnetic pickup amplifier 44, or by a physical presence sensor that is activated when a card 30 is swiped.

The fingerprint retrieval module 410 retrieves fingerprint characterization data from the fingerprint sensor module 60. In one embodiment, the SOC 50 does not process fingerprint image data, which is instead processed within the fingerprint sensor module 60. In one embodiment, the fingerprint retrieval module 410 triggers the fingerprint sensor module 60 to read a fingerprint, and then retrieves fingerprint characterization data from the fingerprint sensor module 60 via the interface 62 on the SOC 50.

The encryption module 415 receives magnetic card and fingerprint characterization data (collectively, user data), and encrypts the data to generate an encrypted rendering of the data.

The error correction module 420 augments the encrypted data with plaintext error correction and detection codes. The error correction module 420 employs and implements robust error correction. For example, the error correction module 420 may implement a trellis code and highly robust checksum protection. In some embodiments of the device software 53, the error correction module 420 is omitted.

The modulator module 425 receives the encrypted data and related error correction code data (if any) and modulates the data to generate a raw audio signal rendering of the user data for transmission via the cellular phone audio channel. The modulator module 425 may include a device driver for driving an on-chip D/A converter 58 to generate an audio output signal corresponding to the raw audio rendering. Alternately, a separate device driver may be configured to receive the raw audio data to drive the on-chip D/A converter 58 and to generate the audio output signal. In one embodiment, the modulation process is performed assuming no channel characterization for the audio path to the upstream service application. In this case, a symbol rate of approximately 300 baud or less is used, though different symbol rates may be used in other embodiments.

Turning now to FIG. 5, illustrated is one embodiment of a computing device 500 that can be used as host system 180 in communication with cell phone 20 for processing transactions initiated at point of access device 10. In one embodiment, the computing device 500 includes one or more processing units (CPUs) 502, one or more network communications interfaces 508, a memory 506, and one or more communication buses 508 for enabling communication between these components. The communication buses 508 may include circuitry (sometimes called a chipset) that interconnects and controls communications between system components. Computing device 500 may include a user interface 510 comprising an output (e.g. display) device 512 and an input device (e.g., keyboard) 514.

Memory 506 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the processors 502. Memory 506, or one or more of the storage devices e.g., one or more non-volatile storage devices) in memory 506, includes a non-transitory computer readable storage medium. In some embodiments, memory 506 or the computer readable storage medium of memory 506 stores the following programs, modules and data structures, or a subset thereof: an operating system 516, a network communication module 518, the service application 185, and a user database 530. The operating system 516 includes procedures for handling various basic system services and for performing hardware dependent tasks. The network communication module 518 enables communication between the computing device 500 and other computers via the one or more communication network interfaces 508 and one or more communication networks, such as the Internet, other wide area networks, local area networks, metropolitan area networks, and so on. The user database 530 stores user records. User records may include, for example, (i) user identifiers associated with the user (e.g., user's name, address, etc.); (ii) user's biometric data, such as fingerprint data; (iii) a mobile device identifier associated with the user, such as a mobile phone number, an IDEN number, etc.; and (iv) private financial information of the user, such as credit card information, bank information, or other financial information which may be used to facilitate online transactions by user, and the like.

In one embodiment, the service application 185 for the point of access device 10 is integrated into an overall service application configured to accept an incoming phone call from the phone 20 and to record audio associated with the phone call. When the point of access device 10 is triggered to send user data (e.g., upon a user depressing the send button 38, or automatically when sufficient user data is captured) to the service application 185, the service application 185 captures a block of audio data corresponding to the modulated, encrypted user data and corresponding error correction codes, lo one embodiment, the service application 185 comprises various modules executable by the processor 502 and configured to facilitate communication with the point of access device, including a demodulation module 522, an error correction module 524, a decryption module 526, and a transaction processing module 528.

The demodulation module 522 receives captured audio data and processes the audio data to retrieve embedded data comprising the encrypted user data and related error correction code data (if any).

The error correction module 524 receives the demodulated encrypted user data and error correction code data and performs error correction and detection. If an uncorrectable error is detected, the error correction module 524 generates and transmits a notification to the point of access device 10 to alert the user to re-send data. For example, the notification triggers one of the indicators 36 and 38 on the point of access device 10. If error correction is successful, the error correction module 524 generates an error-corrected block of encrypted data.

The decryption module 526 receives the block of encrypted data from the error correction module 524 and decrypts the data to produce a block of plaintext user data, including the financial data collected from the magnetic card 30 and the user's fingerprint data collected by the fingerprint data collection module 60.

The transaction processing module 528 uses the plaintext user data generated by the decryption module 526 to complete a transaction.

FIG. 6 illustrates a process 600 for authorizing a transaction using financial data and fingerprint data collected by the point of access device 10, according to one embodiment. In one embodiment, the process 600 comprises interactions between the point of access device 10, the cell phone 20, and the host system 180. In other embodiments, steps of the process 600 are executed by different entities than those illustrated in FIG. 6, and the process 600 includes additional, fewer, or different steps.

The method 600 begins operation when a magnetic stripe card 30 is swiped through the slot 14, in response to which the magnetic pickup 42 reads data stored in the magnetic stripe 32 and generates an analog signal or waveform indicative of data stored in the magnetic stripe 32 (602). The analog waveform is amplified by amplifier 44 and converted to a digital signal by A/D converter 46 (604). A fingerprint scan is performed by fingerprint sensor 60 to generate a fingerprint characterization (606). The magnetic card swipe data and fingerprint scan data (collectively, “user data”) are encrypted (608). Encrypted data is augmented with an error correction and detection code (610). Encrypted data and related error correction code data (if any) is modulated (612) to generate a raw audio signal rendering of the user data for transmission via the cellular phone audio channel (614). In one embodiment, the encrypted data is modulated for transmission via the cellular phone audio channel as a unidirectional push operation.

In one embodiment, the cell phone 20 receives the modulated signal from the point of access device 10 and transmits the user data to the service application 185 executed by the host system 180 (616), for example via a mobile communications network. In another embodiment, cell phone 20 is omitted and the point of access device 10 directly transmits the audio signal to the host system 180.

The service application 185 executed by the host system 180 receives captured audio data and processes the audio data to retrieve embedded data comprising the encrypted user data and related error correction code data (if any) (618). An error correction module of the service application 185 receives the demodulated encrypted user data and error correction code data and applies error correction and detection as needed (620). If uncorrectable error is detected, the host system 180 notifies a user of the device to re-send data, for example by triggering one of the indicators 36 and 38 (621). A decryption module of the service application 185 receives the error-corrected block of encrypted data and decrypts the data to produce a block of data that may be used by the service application to complete a transaction that is in progress (622). The service application 185 authorizes or denies the transaction with the fingerprint scan (624). Thus, for example, if the fingerprint data matches stored data (e.g., as may be stored in a database 690 associated with remote host system 180) for the user associated with the card 30, then the transaction is approved (626) and card 30 is used to make payment (628).

In one embodiment, if the service application 185 authorizes the transaction, money deducted from the account of the holder of card 30 is transferred into an account associated with an owner of cell phone 20. In another embodiment, if the service application 185 authorizes the transaction, money deducted from the account of the holder of card 30 is transferred into an account associated with point of access device 10. In this way, a debt can be collected or paid by use of the point of access device 10. Furthermore, the point of access device 10 may be employed to execute a one-way transaction in which money can be credited to an account. Accordingly, the point of access device 10 allows a user to become either a micro-merchant (payee) or a customer (payer).

FIG. 7 illustrates a schematic block diagram of a biometric authorization system 700 according to an embodiment of the present invention. A radio 710 (as may be included either in cell phone 20 as per system 200 or point of access device 10 as per system 250) initiates SMS messages 720 with data indicative of biometric information for a user. Data indicative of biometric information can be obtained via biometric data gathering device 715 (e.g., fingerprint scanner 13 of device 10). Biometric information is divided into chunks, encrypted, and sent as SMS messages 720 over a mobile communication network 770. In one embodiment, the mobile communication network 770 includes an antenna 730, mobile base station 740, a wide area network 750, and an SMS transaction gateway server 760. SMS messages 720 are received at a biometric processing server 780 (which in one embodiment is a component of the host system 180) via the SMS transaction gateway server 760 for processing. The biometric processing server 780 parses the SMS messages 720, pieces together the biometric data, authorizes it against biometric data stored in the user information database 790 (e.g., the user database 530 of the host system 180), and sends one or more return SMS messages to radio 710 verifying the user.

In the embodiment illustrated in FIG. 7, biometric processing server 780 is in communication with the mobile communication network 770 without an intermediate wide area network (e.g., the Internet) between the biometric processing server 780 and mobile communication network. 770. In this case, the biometric data may be processed offline, which can be advantageous in situations where access to the Internet is unreliable but mobile communication network 170 is capable of transmitting SMS messages. In another embodiment (not shown), the biometric processing server 180 is in communication with the mobile communication network 170 via an intermediate wide area network (e.g., the Internet).

Because the biometric data is processed at a biometric processing server 780 remote from the biometric data gathering device 715, a sufficient amount of biometric data can be gathered by the device 715 to accurately and reliably distinguish between users without adding complexity to the biometric data gathering device 715 or the radio 710.

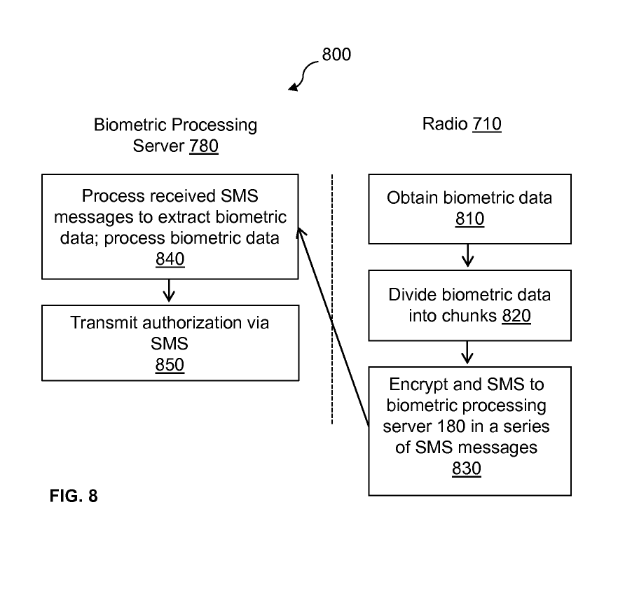

FIG. 8 illustrates a method 800 of using a radio 710 as a biometric authorization device, according to one embodiment. Process 800 begins with radio 710 obtaining biometric data for a user (810). In the embodiments illustrated in FIGS. 1-3, a built-in biometric data gathering device(e.g., fingerprint sensor 13) is described. In other embodiments, an external biometric data gathering device is employed. For example, device 10 may be coupled to a fingerprint reader attachment that can be used to obtain fingerprint data for the user. Other types of biometric data reader devices can be used to obtain biometric data at radio 710,

At 820, the biometric data is segmented into data chunks, where each chunk has a data size that is smaller than a size of an SMS message. For example, each chunk may have less than 1120 bits (160 characters) of data. The segmented data is encrypted for transmission to the biometric processing server 780.

At 830, an SMS module on the radio 710 adds appropriate metadata and transmits the biometric data to biometric processing server 780 over mobile communication network 770 as plurality of SMS messages 720. If the biometric data is divided over several SMS messages, the radio 710 may generate concatenated SMS messages. In one embodiment, an address for the biometric processing server 780 is stored in an address book stored on radio 710. In one embodiment, the SMS module generates concatenated SMS messages, each having 160 characters of data.

At the biometric processing server 780, SMS messages 720 are processed (840) to extract the biometric data. The data representing the biometric data is removed and processed to authenticate a user. In one embodiment, the biometric data is matched with biometric data stored in an account database 790.

If the received biometric data matches the stored biometric data for the user, the biometric processing server 780 sends at 850 one or more SMS messages to radio 710 via mobile communication network 770, authorizing the user.

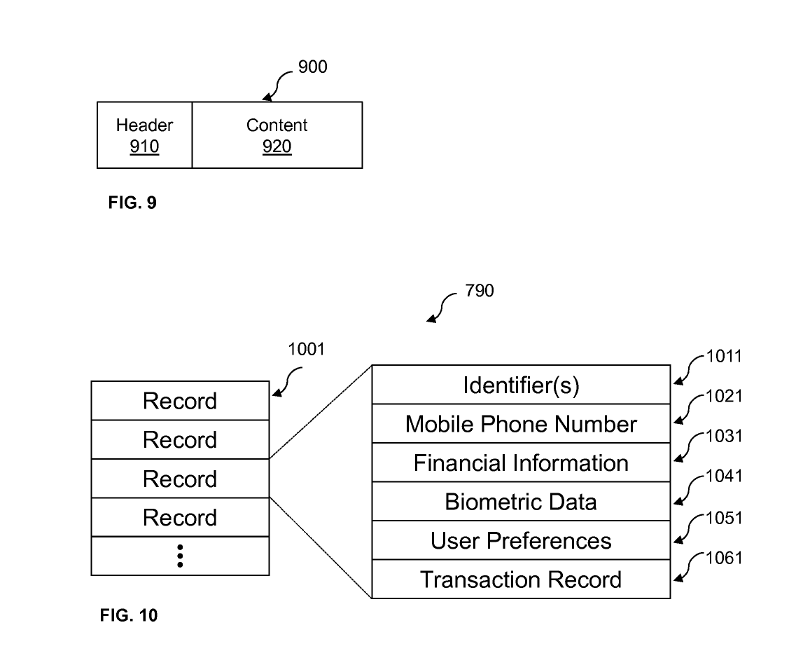

FIG. 9 illustrates a data structure representing a SMS 900, such as may be transmitted by radio 710 or processing server 780. SMS 900 includes a header portion 910 and a content portion 920. Header portion 910 may such information as source and destination port numbers, concatenation information (to support multi-part SMS messages), and the like, while content portion 920 carries the biometric information or a verification of the user.

FIG. 10 illustrates a block diagram of a database structure 790 for storing user account data, according to one embodiment. Database structure 790 contains a set of user account records. A respective user account record 1001 may include such information as: (i) one or more user identifiers 1011 associated with the user (e.g., user name, address, a unique identification number, passport number, social security number, etc), (ii) a mobile phone number 1021 associated with the user, (iii) private financial information 1031 of the user, such as credit card information, bank information, or other financial information which may be used to facilitate online transactions by user, such as amount of funds user has in an associated bank account (iv) biometric data 941, e.g., fingerprint data (v) user preferences 1051 (e.g., a user may request two types of authentication, etc.), and (vi) transaction records 1061 (such as a biometric authentication log) associated with the user record 1001.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or subcombination of the elements from the different species and/or embodiments disclosed herein.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may he described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for authorizing financial transactions at a point of sale device through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A point of access device comprising:
a magnetic card reader adapted to read financial dater stored on a magnetic stripe of a card;
a fingerprint sensor adapted to detect fingerprint data of a user;
a processor adapted to generate an analog signal encoding the financial data and the fingerprint data; and
an output interface adapted to transmit the analog signal via an antenna to a transaction processing server, the transaction processing server using the financial data and the fingerprint data to enable a financial transaction.

2. The point of access device of claim 1, further comprising:
an amplifier coupled to the magnetic card reader, the amplifier receiving a signal indicative of the financial data from the magnetic card reader and amplifying the received signal; and
an analog-to-digital converter coupled to the amplifier, the analog-to-digital converter sampling the amplified signal to generate a digital representation of the financial data.

3. The point of access device of claim 1, wherein the processor is adapted to generate the analog signal encoding the financial data and the fingerprint data by modulating the financial data and the fingerprint data with an analog carrier signal.

4. The point of access device of claim 3, wherein the processor is further adapted to generate the analog signal encoding the financial data and the fingerprint data by augmenting the analog signal with error detection data and error correction data.

5. The point of access device of claim 1, wherein the output interface comprises an audio output line adapted to couple the point of access device to a cellular phone via a microphone channel of the cellular phone, the cellular phone comprising the antenna for transmitting the analog signal to the transaction processing server, the analog signal transmitted to the cellular phone when the point of access device is coupled to the cellular phone.

6. The point of access device of claim 1, wherein the output interface comprises an antenna adapted to transmit the analog signal to the transaction processing server.

7. A method for enabling a financial transaction using a point of access device, the point of access device comprising a magnetic card reader and a fingerprint sensor, the method comprising:
reading, by the magnetic card reader, financial data stored on a magnetic stripe of a card;
detecting, by the fingerprint sensor, fingerprint data of a user;
generating an analog signal encoding the financial data and the fingerprint data; and
transmitting the analog signal via an antenna to a transaction processing server, the transaction processing server using the financial data and the fingerprint data to enable a financial transaction.

8. The method of claim 7, further comprising:
amplifying a signal indicative of the financial data received from the magnetic card reader; and
sampling the amplified signal to generate a digital representation of the financial data.

9. The method of claim 7, wherein generating the analog signal encoding the financial data and the fingerprint data comprises modulating the financial data and the fingerprint data with an analog carrier signal.

10. The method of claim 9, further comprising augmenting the analog signal with error detection data and error correction data.

11. The method of claim 7, wherein the point of access device further comprises an audio output line adapted to couple the point of access device to a cellular phone via a microphone channel of the cellular phone, the cellular phone comprising the antenna for transmitting the analog signal to the transaction processing server, the method further comprising:
transmitting the analog signal to the cellular phone when the point of access device coupled to the cellular phone.

12. The method of claim 7, wherein the point of access device further comprises an antenna adapted to transmit the analog signal to the transaction processing server.

13. A system for enabling a financial transaction, the system comprising:
a point of access device comprising:
a magnetic card reader adapted to read financial data stored on a magnetic stripe of a card,
a fingerprint sensor adapted to detect fingerprint data of a user of the card, and
a processor adapted to generate an analog signal encoding the financial data and the fingerprint data;
a mobile device coupled to the point of access device, the mobile device comprising an interface to receive the analog signal from the point of access device and an antenna to transmit the analog signal; and
a transaction processing system, the transaction processing system comprising an interface for receiving the analog data from the mobile device and a processor for processing the analog signal encoding the financial data and the fingerprint data, the transaction processing server enabling the financial transaction based on the processed signal.

14. The system of claim 13, wherein the processor of the point of access device is adapted to generate the analog signal encoding the financial data and the fingerprint data by modulating the financial data and the fingerprint data with an analog carrier signal.

15. The system of claim 14, wherein the processor of the point of access device is further adapted to generate the analog signal encoding the financial data and the fingerprint data by augmenting the analog signal with error detection data and error correction data.

16. The point of access device of claim 1, wherein the interface to receive the analog signal from the point of access device comprises a microphone input channel, and wherein the point of access device further comprises an audio output line adapted to couple the point of access device to the microphone channel, the analog signal transmitted to the mobile device when the point of access device is coupled to the mobile device.
